(19) United States
(12) Patent Application Publication
(10) Pub. No.: US 2005/0240445 A1
(43) Pub. Date: Oct. 27, 2005

(54) Medical archive library and method

(76) Inventors: Michael Sutherland, Long Grove, IL (US); Koyo Yokoi, East Meadow, NY (US)

Correspondence Address: MORGAN LEWIS & BOCKIUS LLP, 1111 PENNSYLVANIA AVENUE NW, WASHINGTON, DC, 20004, US

(21) Appl. No.: 11/079,529

(22) Filed: Mar. 15, 2005

Related U.S. Application Data
(63) Continuation-in-part of application No. 09/161,753, filed on Sep. 29, 1998.

(51) Int. Cl. G06F 3/00

(52) U.S. Cl. 705/3

(57) ABSTRACT

A low-cost scaleable turnkey system and method for archiving medical image data. The archive system and method permits the selective storing of medical data (including image data) received from a medical modality (e.g., CT, MRI, etc.) onto a removable medium (e.g., DVD or Blu-ray), which may subsequently be placed via robotics in a magazine within the system housing. In addition to directing the archiving of the medical data as described, software components of the archive system permit a specific medium in a magazine to be addressed, retrieved, and read as needed.

This application is a continuation-in-part application of U.S. patent application Ser. No. 09/161,753 filed Sep. 29, 1998, which is hereby incorporated by reference.

### BACKGROUND OF THE INVENTION

1. Field of the Invention

The present invention relates generally to medical image recording systems, and more specifically, to the recording and archiving of medical images that are generated by one or more medical modalities onto removable media.

2. Discussion of the Related Art

The medical industry is undergoing a technical revolution. The demand for remote access to diagnostic information has exposed the inadequacy of traditional media such as film, magneto optical (MO) disk, and tape which hinders duplication and transport. Modem network and computing technology provides a natural solution to an industry that is driven by the accuracy and availability of diagnostic information.

Small review stations, desktop personal computers (PCs), and notebook computers are being installed in hospitals, physician offices, and physician homes all over the world in an effort to provide greater and more cost effective access to patient images and information. This installation trend is happening at a very rapid pace. In addition, compact disc (CD) read-only memory (ROM) readers are being installed on all of these review stations and personal computers.

Hospitals and physicians are demanding immediate access to patient images and patient data in an effort to utilize these low cost-viewing stations. Ideally, patient images would be downloaded from a centralized server via an expansive communications network. However, such broad connectivity is currently unavailable. Thus, what is needed is a practical image management solution that addresses the needs of physicians while also working with the limitations of the present technical environment. This solution should address concerns involving the acquisition, distribution, and archival storage of medical images that are being generated by one or more medical modalities.

### SUMMARY OF THE INVENTION

Accordingly, the present invention is directed to a removable medium recording station that enhances access, distribution, and archiving of medical images. In one embodiment, the removable medium recording station records medical image data in a digital imaging and communications in medicine (DICOM) format onto a removable medium (e.g., CD or blue laser media). The inventive removable medium recording station can be used in conjunction with existing medical imaging systems and networks to provide a cost effective means to deliver medical images to a large installed base of, for example, CD ROM readers around the world. In another embodiment, the removable medium recording station and automated archive robotics (e.g., an archive jukebox) may be combined to provide a low-cost scaleable turnkey system for archiving medical image data. In this latter embodiment, the archive system permits the selective storing of medical data (including image data) received from a medical modality (e.g., CT, MRI, etc.) onto a removable medium (e.g., DVD), which may subsequently be placed via the automated robotics in a magazine within the system housing.

In a first application, the removable medium recording station can be connected to a medical modality that includes a stand-alone medical image workstation and a medical scanner. The medical scanner can be of any type, including but not limited to X-ray, computed tomography (CT), magnetic resonance (MR), Nuclear Medicine, Ultrasound, Angiography, Mammography, Positron Emission Tomography, Computed Radiography, etc. The medical scanner scans a patient and transfers medical image data to the stand-alone workstation. The stand-alone workstation processes the raw image data using one or more diagnostic algorithm to produce processed image data.

The removable medium recording station can be used to effectively replace an installed storage device on the stand-alone workstation. For example, the removable medium recording station can be used to effectively replace a MO drive installed within the stand-alone workstation with a writable CD drive contained within the removable medium recording station. This effective replacement of the installed storage device on the stand-alone workstation eliminates the large undertaking of changing software drivers in the stand-alone workstation and obtaining regulatory approval for validation of the change. Elimination of these elements reduces the costs and minimizes the effect on the medical modality system operation.

Generally, by attaching a peripheral-type removable medium recording station to the stand-alone workstation, the raw image data and the processed image data need not be stored in a first storage format onto a removable medium of a first type inserted into the installed storage device within the stand-alone workstation. Rather, the raw image data and the processed image data are sent to the removable medium recording station that is coupled to the stand-alone workstation. The removable medium recording station enables the operator to store the received raw image data and the processed image data in a second storage format onto a removable medium of a second type. The second storage format (e.g., DICOM) and the removable medium of the second type (e.g., CD, DVD) are dependent upon the current state of the industry.

Thus, the outboard storage operation enables an operator to store medical image data in a particular format and/or removable storage medium that promotes the accessibility and distribution of the medical images. Additionally, since the recording station can playback medical images through the stand-alone workstation, this eliminates the need for the removable medium of the first type. In a preferred embodiment, the removable medium recording station stores medical image data in a DICOM format onto a CD.

In a second application, the removable medium recording station can be connected to an existing modality network. The existing modality network can include a plurality of scanners (e.g., CT and MR), associated workstations, an archive server, and a hospital information system/radiology information system (HIS/RIS). In this modality network, images created by the plurality of scanners are initially analyzed at the associated workstation. The associated workstations transfer the medical image data to the archive server for storage. The archive server saves the medical image data along with patient/procedure information. This modality network represents an enterprise level solution.

The removable medium recording station can be connected to a modality network as a peripheral-type device. It does not change the basic functionality of the modality network. Rather, it expands upon the access and distribution of medical images that are generated and stored within the modality network.

In a similar manner to the first application, the removable medium recording station permits an operator to store medical image data in a particular storage format and on a particular removable storage medium that is supported by the removable medium recording station. In a preferred embodiment, the removable medium recording station stores medical image data in a DICOM format onto a CD. The medical image data is transferred to the removable medium recording station via the communications network connecting the various pieces of the modality network. The removable medium recording station can then record the received medical image data in a particular storage format and on a particular removable storage medium that it supports.

Accordingly, it is a feature of the present invention that the peripheral-type removable medium recording station enables a hospital or other medical service provider to use new storage formats (e.g., DICOM) and mediums (e.g., CD, DAT, DVD, etc.) without modifying existing medical systems and networks. Further, the ability to support new storage formats and mediums through the addition of a peripheral-type device allows a hospital or medical system manufacturer to invest in or use current formats and mediums (proprietary or standardized) without losing the opportunity to take advantage of new storage formats and mediums that are universally accepted in the future. Until the medical system technology fully evolves in its use of standardized storage formats and mediums, a hospital or manufacturer may be unwilling to make the full investment into new technology. The removable medium recording station permits a hospital or manufacturer to use new technologies with a modest investment without sacrificing current and/or past investments.

It is a further feature of the present invention that the removable medium recording station includes a pair of removable medium drives. This pair of removable medium drives enables an operator to efficiently copy the contents (i.e., medical image data) of a first removable medium to a second removable medium. For example, a pair of removable medium drives could be used to copy a patient study contained on a first removable medium onto a second removable medium. It is significant that the generation of a second removable medium does not involve interaction with an archive controller or with a stand-alone workstation having the patient study recorded therein. No searching and retrieval of medical image data from a medical system or network is required. Accordingly, the multiple drives facilitate the copying of information without disruption to the processing of the medical modality and efficient distribution of medical images is thereby achieved.

These multiple removable media drives also serve to enhance the archive capability of the present invention. An archive system of the present invention associated with one medical modality may receive information for archiving from other medical modalities when the removable media drives incorporated in the archive system are compatible with removable media drives incorporated by the medical modalities. Here again, the use of the present invention permits a hospital or manufacturer to take advantage of new technologies through a modest investment and without sacrificing current and/or past investments.

It is to be understood that both the foregoing general description and the following detailed description are exemplary and explanatory and are intended to provide further explanation of the invention as claimed.

### BRIEF DESCRIPTION OF THE ATTACHED DRAWINGS

The accompanying drawings, which are included to provide a further understanding of the invention and are incorporated in and constitute a part of this specification, illustrate embodiments of the invention that together with the description serve to explain the principles of the invention. In the drawings:

FIG. 1 illustrates an embodiment of a removable medium recording station;

FIG. 2 illustrates the connection of a removable medium recording station to a stand-alone workstation;

FIG. 3 illustrates a processing sequence of image data transferred between a stand-alone workstation and a removable medium recording station; and

FIG. 4 illustrates the connection of a removable medium recording station to a modality network.

FIG. 5 illustrates the archive library embodiment of the present invention.

FIG. 6 illustrates the architecture of the archive library embodiment.

FIG. 7 illustrates the plug and play capability of the archive library embodiment.

FIG. 8 illustrates an integration of the archive library embodiment into a medical system.

### DETAILED DESCRIPTION OF THE PREFERRED EMBODIMENTS

Reference will now be made in detail to the preferred embodiments of the present invention, examples of which are illustrated in the accompanying drawings.

Patient diagnosis and care has been greatly aided by the advancements in medical imaging technology. Medical images created by diagnostic modalities such as X-ray, CT, MR, Nuclear Medicine, Ultrasound, Angiography, Mammography, Positron Emission Tomography, Computed Radiography, etc. are routinely used by physicians. Maintaining efficient access to images created by the various modalities is of critical concern to today's physician. In particular, medical image review must not be bound by the physical limitations of traditional viewing media such as film or nonstandard media formats such as MO and DLT.

The medical industry recognizes the need to modernize image viewing capabilities and has begun to install small, low-cost, PC-based review stations. These low cost review stations can be configured with specialized image viewing software that can read specific file formats (e.g., DICOM). Conventional medical modality systems and networks use file formats that are often proprietary and therefore dependent upon the manufacturer of the medical imaging device and/or the manufacturer of the viewing workstation coupled to the medical imaging device. Medical diagnostic images stored in these proprietary formats are viewable at the workstations only. In other words, images stored in these proprietary formats are not freely transportable for viewing at many of today's PC-based review stations.

Of even greater concern in utilizing the low-cost review stations is the problem of image distribution. Ideally, each of the review stations would be connected to a centralized server via a communications network. Medical images, regardless of file format, could then be downloaded to the various review stations upon request. It is unclear when this ideal network scenario will be realized.

The present invention is generally responsive to the real limitations of the current image viewing capabilities within the medical industry. Access and distribution issues are of paramount importance and are addressed by the features of the inventive medical removable medium recording station. These features are described below with reference to the inventive removable medium recording station's connectivity to existing medical systems and networks.

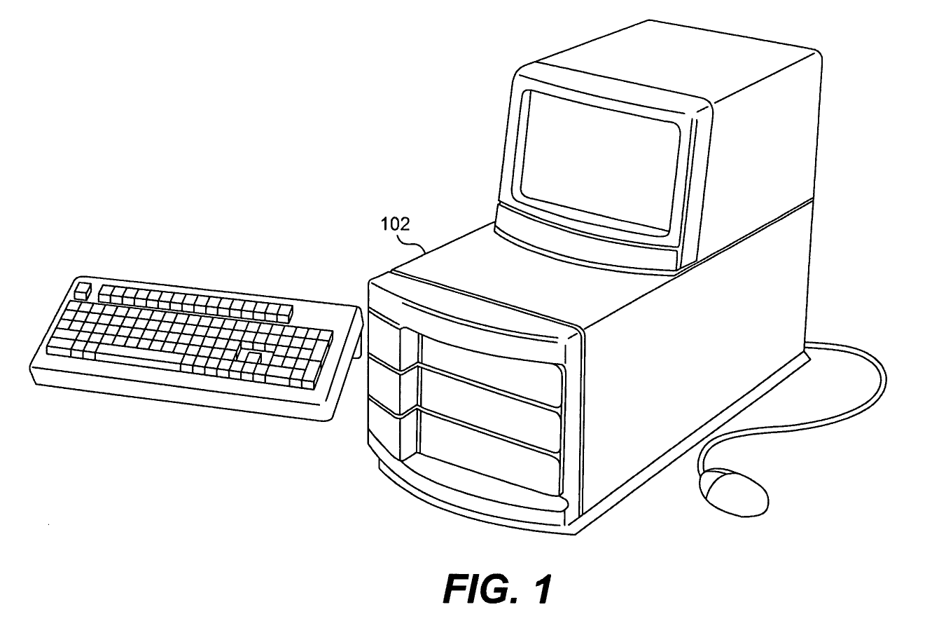

FIG. 1 illustrates an embodiment of a removable medium recording station 102. The particular design of the removable medium recording station 102 illustrated in FIG. 1, can include processing (e.g., Pentium™ processor) and memory facilities (i.e., RAM, hard drive, etc.) similar to a standard PC, a communication facility (e.g., Ethernet network card) for connection to a medical system or network, a removable medium recorder, and a removable medium reader. In one embodiment, the removable medium recorder and the removable medium reader represent the same type of hardware device. In another embodiment, the removable medium recorder and the removable medium reader are distinct hardware devices (e.g., CD recorder and CD ROM reader). Software for controlling the various facilities can be configured to run within an operating system such as Windows NT™. Removable medium recording station 102 also includes DICOM software component for performing network communication, query, retrieval, and database functions, and a removable medium software component for reading (writing) from (to) a particular removable medium (e.g., CD, DVD, DAT, Blu-ray, etc.). In an alternative embodiment, removable medium recording station 102 is designed as a standard off the shelf PC mini-tower.

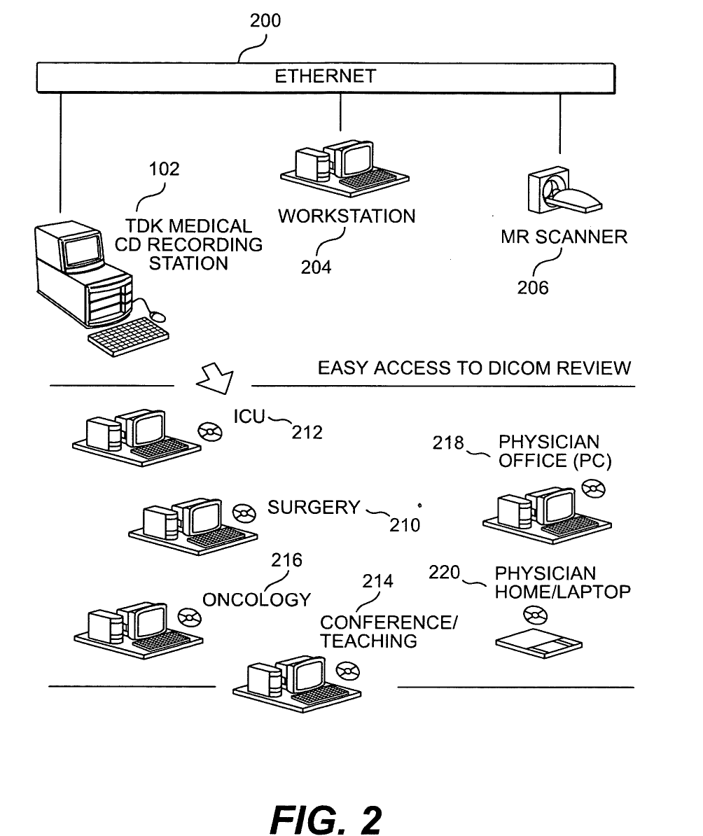

FIG. 2 illustrates a first application wherein removable medium recording station 102 is coupled to a single stand-alone workstation 204 and MR scanner 206. In operation, MR scanner 206 generates patient medical images, which are subsequently stored in workstation 204 for future analysis. Workstation 204 and MR scanner 206 in combination represent a single medical modality. Generally, workstation 204 stores and processes raw image data produced by MR scanner 206. Processed image data is then delivered to a laser camera (not shown) to produce viewable film. Workstation 204 also includes a storage device for storing information on removable digital media. Various types of non-standardized storage devices can be installed on workstation 204.

For example, in most CT workstations, MO drives are installed. Currently, there are approximately twenty different types of MO formats, none of which are compatible with each other. Because of this fragmented state of the medical industry, distribution of patient images is significantly hindered. Each different type of MO drive format requires separate viewing station hardware and software. As illustrated in FIG. 2, separate viewing hardware can be located in surgery 210, in the intensive care unit (ICU) 212 , in a conference/teaching session 214, in oncology 216, in a physician office 218, or in a physician home/laptop system 220.

The challenge for a hospital is to identify a migration path by which utility of the medical image systems are increased without losing a substantial portion of the investment in the original workstations. Merely swapping the storage device, e.g., switching from one type of MO drive to another type of MO drive, or switching from a MO drive to a different type of drive (e.g., CD, DAT, DVD, etc.) is a major undertaking. This results because the application software in the workstation/scanner will not allow easy changes. Moreover, to accommodate new removable medium drive, the software drivers in the workstation would also have to be changed. The workstation is completely dependent on the storage device installed on its machine.

Thus, what would appear to be a simple change (i.e., drive swap) could require a high man hour investment on the part of the workstation/scanner manufacturer. In addition, there are regulatory issues involving the validation of a recording device. The scanner was originally validated to work with a particular MO drive. Any changes to the original workstation specification has to be validated and submitted to the appropriate regulatory bodies for approval. Generally, companies are very careful about changing drives or media formats.

In this environment, a hospital is clearly limited in expanding the distribution and access capabilities for medical images while retaining the bulk of its original investment in the workstation and scanners. What is needed is a solution that allows a hospital to retain the maximum flexibility in its progression to standardized media and file formats.

The present invention greatly expands a hospital's flexibility. This flexibility is achieved by allowing a hospital to upgrade the storage device on existing workstations without actually replacing the existing storage device. This replacement of an existing storage device within workstation 204 is effected through the use of an outboard storage device contained within removable medium recording station 102. As will be shown, this drive replacement provides enormous flexibility to the hardware manufacturer and user.

The storage device within removable medium recording station 102 functions independently of workstation 204. Removable medium recording station 102 is coupled to a network output port on workstation 204. Removable medium recording station 102 can be connected directly to the network output port or through a hub-type device having a plurality of outputs. In a preferred embodiment, the network connection and communication is defined by the DICOM standard. Generally, the DICOM standard uses standard network facilities for interconnection (TCP/IP and ISO-OSI), a mechanism of association establishment that allows for negotiation of how messages are to be transferred, and an object-oriented specification of Information Objects and Service Classes.

In operation, removable medium recording station 102 performs as a DICOM storage service class provider (SCP), which enables it to receive DICOM images, and as a DICOM query/retrieve SCP, which enables it to respond to a query/retrieve request from workstation 204. Correspondingly, workstation 204 performs as a DICOM storage service class user (SCU), which enables it to send DICOM images, and as a DICOM query/retrieve SCU, which enables it to view and pull DICOM images from removable medium recording station 102. In alternative operation modes, the removable medium recording station 102 operating as a SCU can perform a DICOM push to the workstation 204, which performs as a SCP. The roles of both removable medium recording station 102 and workstation 204 will become apparent from the following description of a processing sequence within modality system 200.

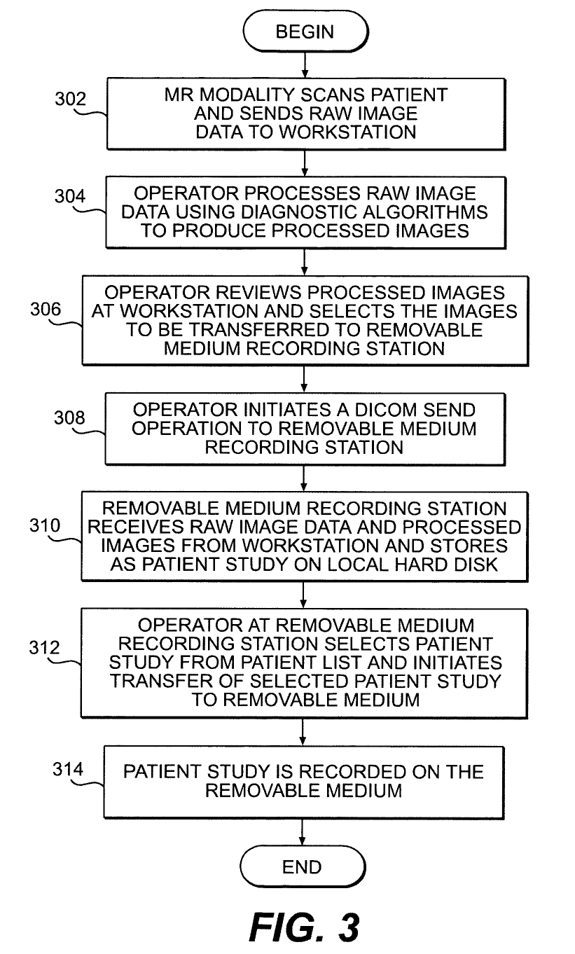

FIG. 3 illustrates an exemplary processing sequence of modality system 200. The process begins at step 302 where MR scanner 206 scans a patient and sends raw image data generated by the scans to workstation 204. Workstation 204 initially stores the raw image data on a local hard disk (not shown). At step 304, the raw image data is then processed at workstation 204. The processing is directed by an operator of workstation 204 and uses one or more diagnostic algorithms to interpret and analyze the raw image data. For example, the diagnostic algorithms could be designed to identify specific diseased conditions within patient tissue or bones that are the objects of the scan. The diagnostic algorithm processing produces processed image data that can be displayed on the screen of workstation 204. This screen display data is referred to as secondary capture data.

At step 306, the operator reviews the processed image data and selects the images that are to be analyzed further. Ordinarily, the selected processed image data would be sent to a laser camera (not shown) or to the installed storage device (e.g., MO) within workstation 204. As noted, however, the installed storage device has limited compatibility with other review stations and cannot be easily removed or upgraded.

In the present invention, the selected image data are to be transferred to removable medium recording station 102. This effectively transforms an internal storage operation within workstation 204 into an outboard operation. Thus, removable medium recording station 202 can be used to quickly and inexpensively upgrade existing medical image workstations.

The outboard storage operation is effected in step 308 where the operator initiates a DICOM send operation to removable medium recording station 102. In this step, workstation 204 sends the raw image and secondary capture DICOM objects to removable medium recording station 102. To accommodate this transfer process, removable medium recording station 102 performs as a DICOM storage SCP, which enables it to receive DICOM images, and workstation 204 performs as a DICOM storage SCU, which enables it to send DICOM images.

It should be noted that the raw image and secondary capture DICOM objects may have previously existed in a format proprietary to workstation 204. In this case, the proprietary raw image and secondary capture objects would need to be converted to DICOM objects prior to transmission to removable medium recording station 102.

At step 310, removable medium recording station 102 receives the raw image and secondary capture objects from workstation 204 and stores the objects as a patient study on the local hard disk. Next, at step 312, the operator at removable medium recording station 102 selects a patient study from a patient list and initiates a transfer of the selected patient study to a removable medium that has been inserted into the removable medium recorder drive within removable medium recording station 102. The patient study is then recorded on the removable medium at step 314.

At this point, the patient study on the removable medium (e.g., CD) can be viewed by any DICOM-compliant viewing station having a removable medium reader (e.g., CD ROM reader) and which supports the appropriate modality objects. As illustrated in FIG. 2, separate viewing hardware can be located in surgery 210, in the ICU 212 , in a conference/teaching session 214, in oncology 216, in a physician office 218, or in a physician home/laptop system 220. Universal operability has therefore been realized without incurring the expense of upgrading existing image processing hardware within a hospital's various modalities.

In an alternative processing sequence, the raw image and secondary capture objects are transferred to removable medium recording station 102 automatically. In this processing sequence, removable medium recording station 102 operates as an archive facility, wherein images are stored temporarily within workstation 204 and transferred to removable medium recording station 102 for long-term storage. The transfer of image data to removable medium recording station 102 can be based on a variety of archive algorithms or routines which simulate current hospital work flow for film based archive techniques. For example, workstation 204 can be designed to measure the fullness capacity of the local hard disk in workstation 204 and transfer image data to removable medium recording station 102 when a threshold is exceeded. The archive algorithm can be further designed to selectively send image data to removable medium recording station 102 based upon a measure of utility of images temporarily stored in workstation 204. For example, workstation 204 can be designed to archive the images that have been infrequently accessed. As would be appreciated by one of ordinary skill in the relevant art, any type of auto-archive algorithm could be used with the present invention to accommodate the storage of image data in a standardized format in a storage facility outside of workstation 204.

In one embodiment, a database manager is employed in conjunction with the auto archive elements within the removable medium recording station 102. In a further embodiment, a removable medium juke box is employed in conjunction with the removable medium recording station 102.

The present invention also permits an operator to retrieve images that are stored on a removable medium. This action would be required whenever the images on the removable medium are not available at the workstation 204. One example of this scenario occurs when the images have been transferred to the removable medium recording station 102 for archive purposes. To accommodate retrieval of images from the removable medium, removable medium recording station 102 performs as a DICOM query/retrieve SCP, which enables it to respond to a query/retrieve request from workstation 204 and workstation 204 performs as a DICOM query/retrieve SCU, which enables it to view and pull DICOM images from removable medium recording station 102. Other versions of the software allow the recording station 102 operating as a SCU to provide a DICOM push to DICOM compliant workstations operating as SCPs. This also allows the workstations 204 to view images from the removable medium recording station with the workstation acting as a DICOM SCP.

As noted above, removable medium recording station 102 can include both a removable medium recording device and a removable medium reading device. In one embodiment, the removable medium recording station 102 includes a CD recorder and a CD ROM reader. The CD recorder and the CD ROM reader can be used in tandem to provide a copying facility for medical image CDs. Copying CDs, or any other removable medium employed, is an important function that promotes the access and distribution of medical images. For example, a patient study recorded on a particular removable medium may need to be viewed by a second physician who will provide a second opinion. The two physicians would likely view the patient study at different locations and at different times. Thus, two copies of the patient study on a removable medium are desired.

In a conventional system, the removable medium (e.g., MO) is produced by a medical modality workstation 204 having a single removable medium installed storage device. To generate a second copy of the patient study, the removable medium would have to be inserted into the removable medium installed storage device of workstation 204. The workstation 204 would then copy the patient study recorded on the removable medium onto the hard disk of the workstation 204. After a second removable medium is inserted in place of the master removable medium, the patient study can be copied from the hard disk onto the second removable medium. This conventional process of generating a copy of a patient study is time consuming and inconvenient. Significantly, the process of copying a patient study in this manner is disruptive of the operation of the medical modality because the copying process will occupy the workstation 204 for a significant period of time (e.g., 15 minutes). During this time, the medical modality will effectively experience a period of downtime.

In the present invention, the copying process can be performed independently of a medical modality. The removable medium recording station 102 operates as a peripheral-type device that can be connected to the medical modality workstation 204. To copy a patient study, the master removable medium is inserted into the removable medium reader and a blank removable medium is inserted into the removable medium recorder. The operator can then select the copy command option to copy one or more patient studies stored on the master removable medium to the second removable medium inserted into the removable medium recorder. Not only can the copying be performed at locations remote from the medical modality workstation but the copying can also proceed without disrupting the operation of the medical modality. Moreover, as the removable medium employed by the removable medium recording station is presumably universally accepted, the patient study can be copied on a recording station that is not associated with the medical modality that originally produced the medical images in the patient study. Again, access and distribution of medical images is significantly improved.

In a further embodiment, the removable medium recording station 102 can also include a removable medium storage device that can read medical image data that has been stored in a proprietary format onto a non-universal media type (e.g., MO). Thus, for example, if the removable medium recording station 102 is also configured with appropriate conversion software, the contents of a proprietary-format MO disk can be converted to a DICOM format and subsequently recorded onto a CD. As would be apparent to one of ordinary skill in the relevant art, the conversion and copying process can be applied to any given pair of storage formats and associated removable media. This conversion and copying facility further enhances the access and distribution of medical images.

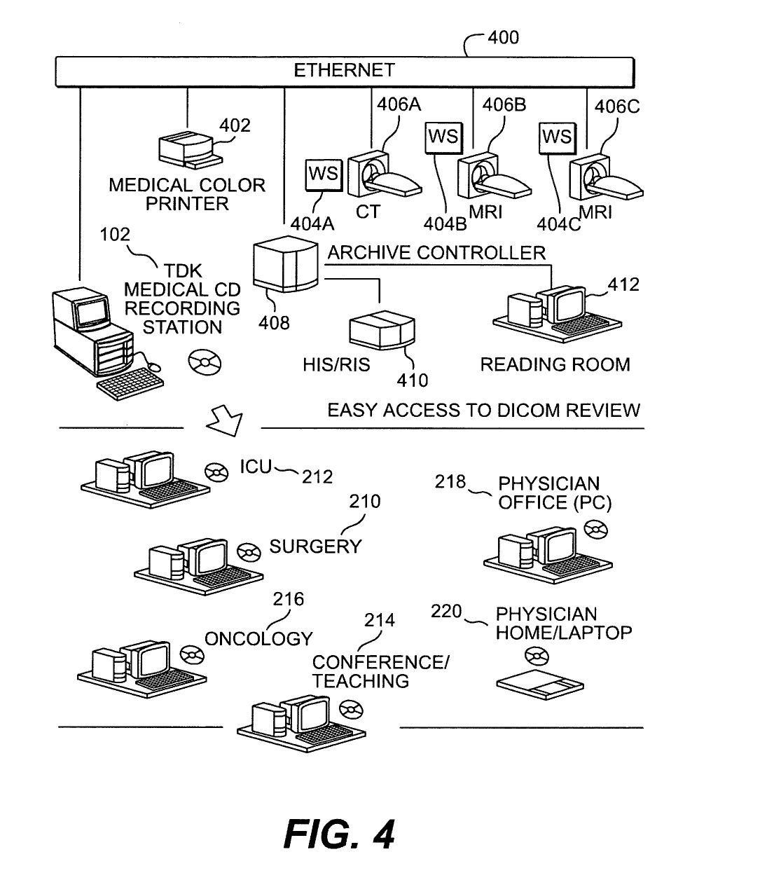

In addition to the operation of the removable medium recording station 102 in connection with a stand-alone workstation 204, removable medium recording station 102 can also be configured to operate with an existing medical modality network. FIG. 4 illustrates the connection of removable medium recording station 102 to an example CT/MR modality network 400. CT/MR modality network 400 includes CT/MR scanners 406A-406C, workstations 404A-404C, medical color printer 402, archive controller 408, hospital information system (HIS)/radiology information system (RIS) 410, and reading room 412. This collection of diagnostic facilities represents an enterprise level solution.

Removable medium recording station 102 can be coupled to any existing modality network such as CT/MR modality network 400. Removable medium recording station 102 offers many of the similar benefits described above in promoting the access and distribution of diagnostic medical images. As described below, removable medium recording station 102 enables a hospital to upgrade their existing medical imaging systems without sacrificing their investment in their enterprise level medical modality network.

In modality network 400, raw image data is generated by one of the CT/MR scanners 406A-406C, which scans a patient and sends the raw image data generated by the scans to an associated workstation 404A-404C. For example, CT scanner 406A sends the generated raw image data to workstation 404A. Workstation 404A initially stores the raw image data on a local hard disk (not shown). The raw image data is then processed at workstation 404A. In the same manner as the processing of FIG. 3, workstation 404A uses one or more diagnostic algorithms to interpret and analyze the raw image data.

An operator can review the processed image data at the workstation 404A and send the selected image data to archive controller 408. Archive controller 408 is operative to permanently archive both the raw image data and the associated secondary capture data. The raw image data and the associated secondary capture data are stored in archive controller 408 along with selected patient data (e.g., doctor, type of procedure, billing info, etc.). Archive controller is the centralized facility that stores diagnostic medical image data.

The diagnostic medical image data can be retrieved from archive controller 408 by reading room viewer 412. Alternatively, reading room system 412 can obtain access to the medical image data through the physical transport of a removable medium. Still further, reading room viewer 412 can be used to view medical image data that has been recorded on film. Generally, the reading room is a location where physicians can focus on images and make their respective diagnosis.

After the operator finishes the diagnosis of the patient based upon the retrieved image data, the secondary capture can be sent to medical color printer 402. The hard copy produced by medical color printer 402 is one form of media through which medical images can be transferred to other locations not coupled to the CT/MR modality network 400. Hard copy introduces significant limitations in the future diagnosis of image data. Another option available to the operator is the storage of the retrieved image data onto the removable media inserted into the storage device of reading room viewer 412. As noted, reading room viewer 412 will store the image data in a proprietary format and/or on non-standardized media.

As illustrated in FIG. 4, the inventive removable medium recording station 102 can be connected to an existing modality network 400. In this environment, removable medium recording station 102 can be used in a variety of ways. First, removable medium recording station can be used in the same manner as if it was connected to a stand-alone workstation 204. This functionality was described above with reference to FIG. 3.

Second, removable medium recording station 102 can be used to retrieve medical image data from archive controller 408. To accommodate retrieval of images from archive controller 408, archive controller 408 performs as a DICOM query/retrieve SCP, which enables it to respond to a query/retrieve request from removable medium recording station 102 and removable medium recording station 102 performs as a DICOM query/retrieve SCU, which enables it to view and pull DICOM images from archive controller 408. After retrieving medical image data from archive controller 408, removable medium recording station 102 stores the raw image and secondary capture objects as a patient study on the local hard disk. An operator at removable medium recording station 102 can then select a patient study from a patient list and initiate a transfer of the selected patient study to a removable medium that has been inserted into the removable medium storage device within removable medium recording station 102. At this point, the patient study on the removable medium can be viewed by any DICOM-compliant viewing station, which supports the appropriate modality objects. As illustrated in FIG. 4, separate viewing hardware can be located in surgery 210, in the ICU 212, in a conference/teaching session 214, in oncology 216, in a physician office 218, or in a physician home/laptop system 220.

Generally, the transfer of images to removable medium recording station 102 is similar to the sending of images to medical color printer 402. Removable medium recording station 102 is operative as a peripheral-type device that can be easily coupled to an existing medical modality network. As removable medium recording station 102 is merely added to the existing medical modality network, no substantial modifications to the existing medical modality network are required. This is especially valuable when considering the hospital's investment in purchasing an enterprise level system.

As described above, the copying facility of removable medium recording station 102 can be used advantageously to eliminate the need to involve workstation 204 to effect the copying. This advantage also applies in the context of connecting removable medium recording station 102 to modality network 400. In this case, removable medium recording station 102 can be used advantageously to eliminate the need to involve any one of workstations 404A-404C to effect the copying.

Moreover, removable medium recording station 102 greatly speeds the generation of a copy of medical image data in those cases where archive controller 408 is involved. Without the use of removable medium recording station 102, an operator would have to locate then retrieve the desired information from archive controller 408. The selected medical image data would then be downloaded to the requesting system's hard disk then finally to a removable medium. This process is time consuming and ineffectual.

The present invention allows the copying to proceed on a removable medium recording station 102 that is not associated with the medical modality workstation or network that originally produced or currently stores the medical images in the patient study. For example, a copy of a patient study can be made at a removable medium recording station 102 located in a hospital different than the one where the modality network that originated the images resides. Again, access and distribution of medical images is significantly improved.

In another embodiment, the removable medium recording station and the archive jukebox may be combined to provide a low-cost scaleable turnkey system for archiving medical image data. Similar to the previous embodiments, the archive system permits the selective storing of medical data (including image data) received from a medical modality (e.g., CT, MRI, etc.) onto a removable medium (e.g., DVD), which may subsequently be placed via automated robotics in a magazine within the system housing. In addition to directing the archiving of the medical data as described, software components of the archive system permit a specific medium in a magazine to be addressed, retrieved, and read as needed. As with the previous embodiments, specific features associated with the archive system include its ability to function as a service class provider and/or a service class user for a variety of service classes including, for example, when receiving studies pushed to it from the modalities or when sending studies to the modalities respectively. Accordingly, this embodiment also incorporates DICOM software for accepting images and reports sent to it from any modality, for storing images and reports on media in DICOM format, and for allowing DICOM viewing clients to retrieve images and reports. Further, this embodiment may also include a web interface to allow browser-based clients to retrieve images.

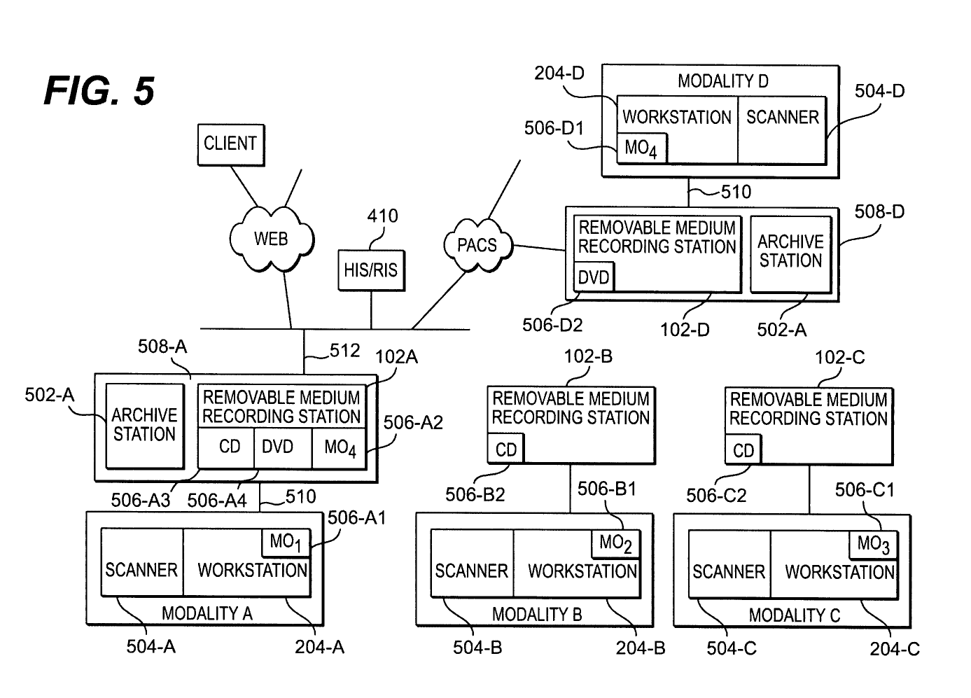

FIG. 5 illustrates an application of this embodiment. FIG. 5 has been simplified for purposes of explanation and is not intended to show every feature of the system. For clarification, system elements in FIG. 5 will be referred to collectively or generically using a three-digit number and will be referred to specifically using an extension separated from the three-digit number by a hyphen. For example, removable medium recording stations 102-A to 102-D will be referred to collectively as removable medium recording stations 102 and an individual removable medium recording station will be referred to generically as removable medium recording station 102 or specifically, for example, as removable medium recording station 102-A.

In FIG. 5, an archive station 502, which may incorporate, for example, the functionality of the archive controller 408, and the removable medium recording station 102 are integrated into an archive library 508. The archive library 508-A is connected to medical modality A via connection 510, which may be a direct connection or a connection via a hub as previously described. FIG. 5 also shows three other medical modalities B, C, and D. Each medical modality in the illustration includes a medical scanner 504 and a workstation 204, which may be separate or integrated entities, with each workstation 204 containing a removable medium drive 506. To illustrate the features of the present embodiment, each removable medium drive 506 of this exemplary system implements a different MO drive format as indicated by the subscripts 1, 2, 3, and 4. As previously mentioned, approximately twenty different types of MO formats are currently used in the medical industry, none of which are compatible with each other. Each archive library 508 may also be connected to various networks such as the Web, HIS/RIS, and PACs networks shown in FIG. 5.

As previously explained, the removable medium recording station 102 may contain multiple removable medium drives to facilitate the copying of information without disruption to the processing of the modality workstation. These multiple drives also serve to enhance the archive capability of the archive system 508. For example, as shown in FIG. 5, the archive system 508-A associated with modality A may store medical data from modalities B and C due to the incorporation of CD drives at each of the respective removable medium recording stations. Once the information has been copied to CD at each of the removable medium recording stations (102-B, 102-C), the CDs may be inserted into the CD drive of removable medium recording station 102-A of modality A to allow the archiving of the medical data in the archive station 502-A. Alternatively, depending on the types of removable medium drives incorporated in the removable medium recording station 102-A, the removable medium associated with a particular workstation may be used to transfer the information to the archive station 502-A. For example, as illustrated in FIG. 5, due to the incorporation of a MO₄ drive in removable medium recording station 102-A, the medical information from modality D may be transferred using MO₄ format/media. Medical information may also be transmitted to the archive library 508-A for storage via the network connections 512. While the FIG. 5 illustration shows drives for CD, DVD, and MO, other removable media/drives will be known to those of ordinary skill in the art and are within the scope of the present invention. For example, the present invention may incorporate removable media/drives for AIT, LTO, and PDD among others. Further, the number of removable media/drives incorporated will depend on the application (i.e., the needs of a particular medical system) and are not intended to be limited to the numbers explicitly illustrated herein. For example, the archive library 508 may not only receive medical data from one or more types of removable media but may also archive the data on one or more types of removable media. And as with the previous embodiments, a removable medium drive may be embodied by a distinct removable medium recorder and a distinct removable medium reader or a single physical hardware device combining both functions. Other configurations for the removable medium hardware and/or software will be known to those of ordinary skill in the art and are within the scope of the present invention.

The archive library 508 may perform as a client as well as a server in a client server environment and may connect to medical imaging modalities, image archive servers (PACS servers), and non-imaging medical information servers via DICOM network protocol. Non-DICOM network protocols may also be used, for example by non-imaging medical information servers, to connect to the archive library 508. Imaging modalities and PACS servers may send medical image data, unsolicited or after query by the archive library software, for receipt by and storage in the archive library 508. Similarly, the archive library 508 may receive and store medical non-image data, for example, diagnostic reports, hemodynamic waveforms, etc., sent unsolicited by imaging modalities and PACS servers and/or after those systems are queried by the archive library software. DICOM formatted medical images of all modalities and DICOM non-image objects (reports, presentation states, waveforms, key image notes, etc.) may be stored in the archive library 508. All information received by the archive library 508 may be forwarded, manually or automatically (e.g., via DICOM Auto Forward service), as output to other servers.

Further, the archive library 508 may automatically store all data received on one or more types of archive media (e.g., optical blue-laser media, DVD, etc.) and may be used to maintain a complete database of all patient information received. The archive library 508 may also provide a Web-based user interface to allow a user to administer and configure the library. Moreover, the archive library 508 may accept and respond to requests by client systems for patient information, retrieving patient information from storage and sending it via DICOM network protocol or via non-DICOM network protocol to requesting clients as appropriate. The library may respond to requests from clients to provide information about objects stored on media, for example, whether the object exists, the date stored, its size, its on-line/off-line status, etc. The library may also acknowledge receipt of data objects and communicate back to the client when the objects have been safely stored on media and provide error reporting and other administrative status messages to the clients. The software of the archive library 508 may communicate to client computers and human operators through various means to include: (1) display of messages on an integrated LCD display; (2) transmission of messages/data objects through the use of DICOM protocol to other DICOM client devices; (3) transmission of messages/data objects through the use of HTTP protocol to Web browsers; and (4) email and pager messages to human administrators.

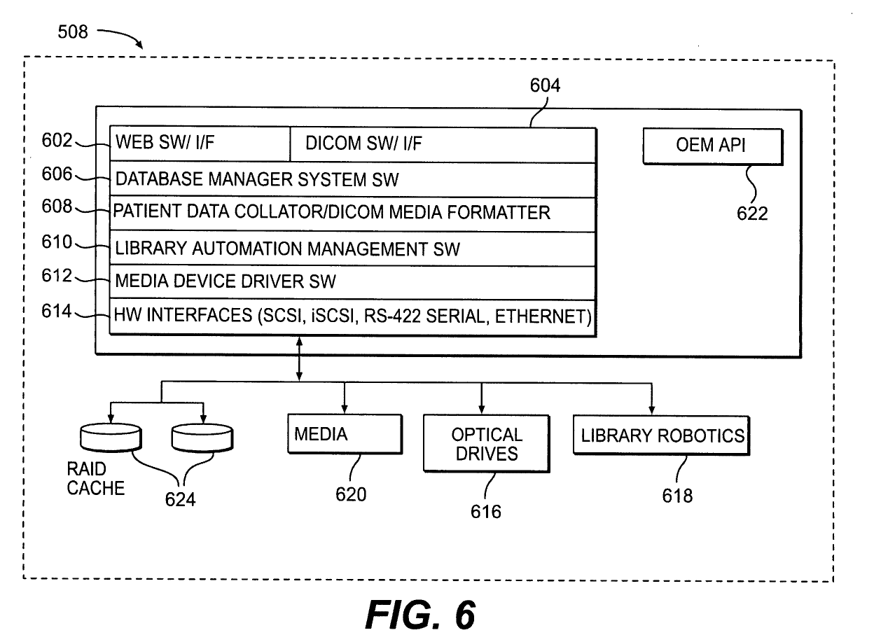

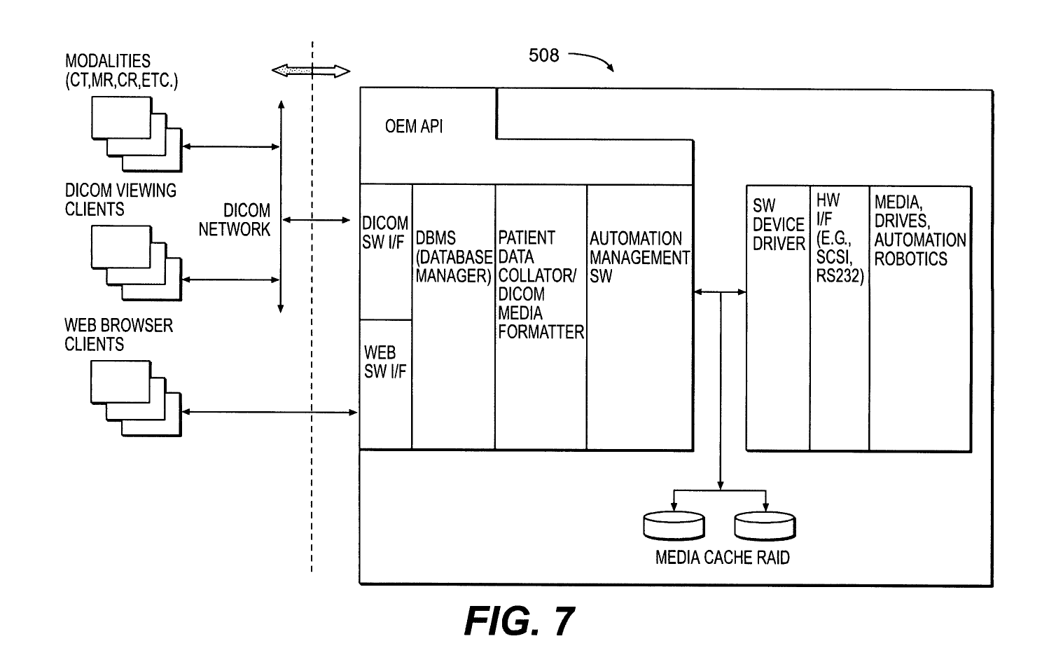

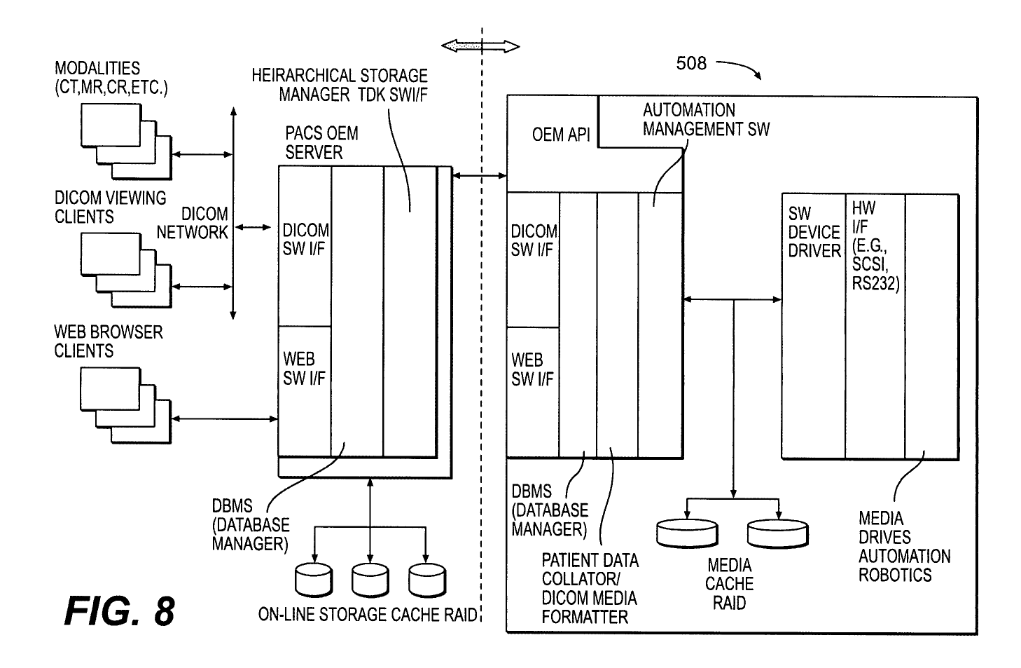

FIGS. 6-8 exemplify the architecture of the archive library 508. As disclosed in connection with the previous embodiments and shown in FIG. 6, the archive library 508 may incorporate a Web SW I/F 602 to connect to Web Browser clients (FIG. 7), a DICOM SW I/F 604 to connect with a DICOM network (FIG. 7), database manager system software 606, a patient data collator/DICOM media formatter 608, library automation management software 610, media device driver software 612, hardware interfaces 614, optical drives 616, library robotics 618, media 620, a rich OEM API 622 to connect with, for example, a PACS OEM server (FIG. 8), and processing facilities (not shown). The archive library 508 may also include RAID cache 624.

FIG. 7 illustrates the plug-and-play capability of the archive library 508. As illustrated, the archive library 508 is a “plug n play” DICOM Device; that is, the archive library 508 is an integrated finished product having all the necessary DICOM SW and database to plug into a DICOM network or hub via network connections (e.g., 100BASE-TX Ethernet connections). Further, as illustrated in FIG. 8, the archive library 508 may be integrated into the medical system by modality or PACS OEM. In FIG. 8, the archive library 508 incorporates a rich OEM API to allow OEM PACS SW applications to access the database and studies directly (i.e., without using DICOM services). Moreover, the archive library 508 may also provide a web I/F to allow browser-based clients to retrieve images.

As with the previous embodiments, the archive library 508 may function as a DICOM Service Class Provider (SCP) and/or a DICOM Service Class User (SCU) with respect to one or more of the following classes of service: Storage, Media Storage, Query/Retrieve, Patient Management, Study Management, and ancillary functionality associated therewith. For example, the unit may operate as a DICOM Storage SCP to receive studies pushed to it from network-connected modalities, and as a DICOM Storage SCU to send studies to the modalities. The archive library 508 may also perform as a DICOM Query/Retrieve client, allowing it to pull studies from DICOM Query servers. Further, like the previous embodiments, the archive library 508 software gathers and groups data according to user-specified rules and formats it for storage on removable media according to DICOM-specified rules or “DICOM Media Profiles.” In the illustrations of FIGS. 6-8, these functions may be implemented by the Patient Data Collator/DICOM Media Formatter 608, which may control, for example, how to group the studies and images together on media, whether to include a particular report, whether to anonymize the medical data, the type of media to be used, whether to include image viewing software, whether to label the media and what information to include, the priority of a request, and the number of copies needed. Feedback and status may also be provided to the medical system such as job status, error conditions, media empty, etc. Other classes of service and ancillary functionality will be known to those of ordinary skill in the art and are within the scope of the invention. For example, the archive library 508 may support the Worklist/Structured Reporting service class, thereby facilitating workflow management, or take and/or give responsibility for image information via the Storage service class ancillary, Storage Commitment.

The scaleability of the archive library 508 further addresses the needs of a particular medical system. Archive libraries 508 may be daisy-chained together to increase capacity. Further, each archive library may have a configurable number of writers. In one embodiment, each archive library 508 supports up to two drives and one hundred PDD bare media and the archive system is scalable from one to four libraries with the maximum number of media from one hundred to four hundred with max capacity of 9.32. (50 discs per magazine). The archive libraries 508 may be daisy-chained together using, for example, USB and SCSI LVD connections.

While the invention has been described in detail and with reference to specific embodiments thereof, it will be apparent to one skilled in the art that various changes and modifications can be made therein without departing from the spirit and scope thereof. Thus, it is intended that the present invention cover the modifications and variations of this invention provided they come within the scope of the appended claims and their equivalents.

1. A method for archiving information in a medical system having a medical scanner that scans a patient and creates medical image data and a computer workstation coupled to the medical scanner for analyzing the medical image data, the method comprising:
receiving medical data from the medical system at a removable medium recording station coupled to the medical system, the removable medium recording station having
a first storage device capable of initially storing medical data received from the medical system on a nonremovable storage medium,
a first removable medium drive capable of receiving a first type of removable media, and,
a second removable medium drive capable of receiving a second type of removable media;
transferring medical data from one of the first storage device and the first removable medium drive to the second removable drive;
removing a removable medium containing the transferred medical data from the second removable medium drive; and
filing the removable medium in a storage facility.

2. The method of claim 1 wherein the removing and the filing of the removable medium is accomplished using robotics.

3. The method of claim 2 wherein filing the removable medium comprises placing the removable medium in a magazine.

4. The method of claim 3 wherein the removable medium recording station, the robotics, and the magazine are encompassed within a single housing.

5. The method of claim 1 wherein the second type of removable media is the same as the first type of removable media.

6. The method of claim 1 wherein the transferring of the medical data comprises selectively storing the received medical data.

7. The method of claim 1 further comprising retrieving medical data from the storage facility unsolicited or on request.

8. The method of claim 7 wherein a request for retrieval of the medical data originates from one of the Web, a PACs network, a HIS/RIS network, the computer workstation, and the removable medium recording station.

9. The method of claim 1 wherein the medical data includes at least medical image data.

10. The method of claim 1 wherein the computer workstation is a digital imaging and communications in medicine compliant computer workstation.

11. The method of claim 1 wherein the first removable medium drive utilizes one of a compact disk, a digital video disk, and blue-laser media.

12. The method of claim 1 wherein the computer workstation has a magneto-optical drive.

13. The method of claim 1 wherein the removable medium recording station has a third removable medium drive for receiving a third type of removable media, the third removable medium drive used in conjunction with the first removable medium drive to copy image data from the first removable medium drive to the third removable medium drive independently of the operation of the medical system.

14. The method of claim 13 wherein the third type of removable media is the same as the first type of removable media.

15. The method of claim 2 wherein the robotics comprise a removable medium juke box.

16. The method of claim 15 wherein the filing of the removable medium comprises the labeling of the removable medium with the pertinent patient information.

17. The method of claim 13 further comprising:
storing image viewing software on the third type of removable media to enable the viewing of the medical image data by non-compliant workstations.

18. The method of claim 17 wherein the image viewing software enables DICOM compliance.

19. The method of claim 1 wherein the medical image data is transmitted from the medical system for receipt at the removable medium recording station when a storage capacity threshold of a nonremovable storage medium of the computer workstation is exceeded.

20. The method of claim 1 wherein the medical data is transmitted from the medical system for receipt at the removable medium recording station in response to a measure of the utility of the medical data stored on a nonremovable storage medium of the computer workstation.

21. The method of claim 13 further comprising:
associating patient data with at least one of the removable medium and a second removable medium of the third type, the patient data corresponding to the medical image data stored on the respective medium.

22. The method of claim 21 wherein the patient data is obtained from a hospital information system/radiology information system.

23. The method of claim 21 wherein the patient data is associated with the respective medium by labeling the medium with the patient data.

24. The method of claim 1 wherein the computer workstation is a standalone workstation including a second storage device capable of storing data on a second nonremovable storage medium and operative to store initially medical image data received from said medical scanner; and a fourth removable medium drive capable of storing data on a fourth type of removable storage media, wherein the fourth type is different from at least the first type of removable media.

25. The method of claim 9 wherein the medical image data received by the removable medium recording station comprises raw data and data processed by the computer workstation.

26. The method of claim 1 wherein the removable medium recording station performs as at least one of a service class provider and a service class user.

27. The method of claim 26 wherein the classes of service comprise at least one of storage, query/retrieve, print management, and patient data management.

28. The method of claim 1 wherein the second removable medium type is one of a compact disk, a digital video disk, and blue-laser media.

29. The method of claim 1 further comprising grouping the medical data and formatting it for storage on the removable medium.

30. A medical archive library comprising:
a communication facility for coupling the medical archive library to a medical system, the medical system having at least one medical scanner that scans a patient and creates medical image data and a computer workstation coupled to the medical scanner for analyzing the medical image data;
a first storage device capable of initially storing medical data received from the medical system on a nonremovable storage medium,
a first removable medium drive capable of receiving a first type of removable media;
a second removable medium drive capable of receiving a second type of removable media;
processing facilities capable of controlling the transfer of medical data from one of the first storage device and the first removable medium drive to the second removable medium drive;
at least one magazine capable of storing the second type of removable media; and,
robotics capable of removing the second type of removable media from the second removable medium drive and filing the second type of removable media in the at least one magazine.

31. The medical archive library of claim 30 wherein the second type of removable media is the same as the first type of removable media.

32. The medical archive library of claim 30 wherein the communication facility also couples the medical archive library to at least one of the Web, a PACs network, and a HIS/RIS network.

33. The medical archive library of claim 30 wherein the medical archive library is encompassed within a single housing.

34. The medical archive library of claim 30 further comprising at least one of a web browser, DICOM software interface, and an OEM API.

35. The medical archive library of claim 30 further comprising software capable of gathering and grouping medical data from the medical system and formatting the medical data for storage on a removable medium inserted in the second removable medium drive.

36. The medical archive library of claim 35 wherein the software determines which DICOM Media Profile to use.

37. The medical archive library of claim 35 wherein the software determines how to group studies and images together on the media.

38. The medical archive library of claim 35 wherein the software determines the type of removable media to be used.

39. The medical archive library of claim 35 wherein the software determines whether to include a particular report.

40. The medical archive library of claim 35 wherein the software determines whether to anonymize the medical data.

41. The medical archive library of claim 35 wherein the software determines the number of copies needed.

42. The medical archive library of claim 35 wherein the software determines whether to include image viewing software on the removable medium.

43. The medical archive library of claim 30 wherein the computer workstation is a digital imaging and communications in medicine compliant computer workstation.

44. The medical archive library of claim 30 wherein the computer workstation has a magneto-optical drive.

45. The medical archive library of claim 30 wherein the first type of removable media is one of a compact disk, a digital video disk, and blue-laser media.

46. The medical archive library of claim 30 further comprising a third removable medium drive for receiving a third type of removable media, the third removable medium drive used in conjunction with the first removable medium drive to copy image data from the first removable medium drive to the third removable medium drive independently of the operation of the medical system.

47. The medical archive library of claim 46 further comprising software capable of gathering and grouping medical data and formatting it for storage to one of the second removable medium drive or the third removable medium drive.

48. The medical archive library of claim 30 wherein the medical data is stored to the second removable medium drive when the medical data stored on the nonremovable storage medium exceeds a capacity threshold of the nonremovable storage medium.

49. The medical archive library of claim 30 wherein the medical image data is stored to the second removable medium drive in response to a measure of the utility of the image data stored on the nonremovable medium.

50. The medical archive library of claim 30 wherein the communications facility couples the medical archive library directly to a network port of the computer workstation.

51. The medical archive library of claim 30 wherein medical image data is transmitted from the medical system to the medical archive library when a storage capacity threshold of a nonremovable storage medium of the computer workstation is exceeded.

52. The medical archive library of claim 30 wherein medical image data is transmitted from the medical image system to the medical archive library in response to a measure of the utility of the medical image data stored on a non-removable storage medium of the computer workstation.

53. The medical archive library of claim 46 wherein image viewing software is stored by the third removable medium drive to enable the viewing of the medical image data by non-compliant workstations.

54. The medical archive library of claim 53 wherein the image viewing software enables DICOM compliance.

55. The medical archive library of claim 30 wherein the medical data includes at least medical image data.

56. The medical archive library of claim 30 wherein medical image data received by the removable medium recording station comprises raw data and data processed by the computer workstation.

57. The medical archive library of claim 30 wherein the removable medium recording station performs as at least one of a service class provider and a service class user.

58. The medical archive library of claim 57 wherein the classes of service comprise at least one of storage, query/retrieve, print management, and patient data management.

59. The medical archive library of claim 46 wherein the third type of removable media is the same as the first type of removable media.

60. The medical archive library of claim 30 wherein the second type of removable media is one of a compact disk, a digital video disk, and blue-laser media.

61. The medical archive library of claim 43 wherein patient data is associated with a removable medium in one of the second removable medium drive and the third removable medium drive, the patient data corresponding to the medical image data stored on the removable medium.

62. The medical archive library of claim 61 wherein the patient data is obtained from a hospital information system/radiology information system.

63. The medical archive library of claim 61 wherein the patient data is associated with the removable medium by labeling the removable medium with the patient data.

64. A medical archive system, comprising:
a communications network;
at least one medical scanner, coupled to said communications network, that scans a patient and creates medical image data;
a computer workstation, coupled to the communication network and operative to store initially and to analyze the medical image data generated by the medical scanner;
a medical archive library, coupled to said communications network, the medical archive library having a first storage device capable of initially storing medical data received from the medical system on a nonremovable storage medium,
a first removable medium drive capable of receiving a first type of removable media,
a second removable medium drive capable of receiving a second type of removable media,
processing facilities capable of transferring medical data from one of the nonremovable storage medium and a first removable medium inserted in the first removable medium drive to a second removable medium inserted in the second removable medium drive, at least one magazine capable of storing the second type of removable media, and,
robotics capable of removing the second type of removable media from the second removable medium drive and filing the second type of removable media in the at least one magazine.

65. The medical archive system of claim 64 wherein the medical archive library further comprises a third removable medium drive for receiving a third type of removable media, the third removable medium drive used in conjunction with the first removable medium drive to copy image data from the first removable medium drive to the third removable medium drive independently of the operation of the medical system.

66. The medical archive system of claim 64 wherein the computer workstation is a digital imaging and communications in medicine compliant computer workstation.

67. The medical archive system of claim 64 wherein the computer workstation has a magneto-optical drive.

68. The medical archive system of claim 64 wherein the first type of removable media is one of a compact disk, a digital video disk, and blue-laser media.

69. The medical archive system of claim 64 wherein the second type of removable storage media is one of a compact disk, a digital video disk, and blue-laser media.

70. The medical archive system of claim 64 wherein a plurality of medical archive libraries are connected together to increase storage capacity.

71. The medical archive system of claim 64 wherein medical data received by the medical archive library includes at least medical image data.

72. The medical archive system of claim 65 wherein the first, second, and third types of removable media are the same type.
